(19) United States
(12) Patent Application Publication
(10) Pub. No.: US 2003/0224626 A1
(43) Pub. Date: Dec. 4, 2003

(54) Modular connector assembly

(75) Inventor: Che-Chia Chang, Taipei (TW)

Correspondence Address: BRUCE H. TROXELL, SUITE 1404, 5205 LEESBURG PIKE, FALLS CHURCH, VA, 22041, US

(73) Assignee: COMAX TECHNOLOGY INC.

(21) Appl. No.: 10/156,004

(22) Filed: May 29, 2002

(51) Int. Cl. H01R 39/00

(52) U.S. Cl. 439/1

(57) ABSTRACT

A multi-connector module for connecting a plurality of peripheral devices to a host comprises a body having a plurality of slots therein. Each slot in the body includes a plurality of signal contacts and is shaped such that the peripheral devices and be connected to the host via a plurality of cables individually plugged in the multi-connector module.

### BACKGROUND OF THE INVENTION

1. Field of The Invention

The present invention relates to a connector assembly. More particularly, the present invention relates to an electrical connector assembly that can accommodate several connections between a host and various devices within a computer system or computer network.

2. Description of Related Art

In current personal computer (PC) structures, the main storage devices are usually a hard disk drive and a CD-ROM drive. With the presently available technology, the hard disk drive and the CD-ROM drive are conventionally connected to a host, usually a motherboard, via the Advanced Technology Attachment (ATA) standard interface for internal storage devices. Practically, a parallel ATA interface is currently used to connect up to two storage devices to single port of the motherboard in a master/slave configuration.

FIG. 1 is a perspective view that schematically shows a typical cable assembly usually employed to achieve a parallel ATA interface. As shown in FIG. 1, to achieve the parallel ATA interface, a wide ribbon cable 10 conventionally provided with three parallel ATA connectors (20, 30, 40) is used to connect one or two devices to motherboard host 55 within the personal computer. Because the parallel ATA standard interface was designed in such a manner that the host 55 can drive up to two storage devices only through a single port, a single parallel ATA connector receptacle 50 is therefore conventionally provided on the motherboard 55. The parallel ATA connectors (20, 30, 40, 50) conventionally have forty pins and the ribbon cable 10 has eighty conductor lines.

As PC processor performance has increased, so have the read/write data rates of the storage devices. For illustration, industrial manufacturers projected the hard disk rate to exceed today's 100 Megabytes per second (MB/s) interface bandwidth by the year 2003. Parallel ATA has kept pace in the past, but is nearing its limit and becomes a performance bottleneck. To replace the parallel ATA interface, the industry is currently developing a Serial ATA interface that will be the next generation of interface for storage devices.

The new serial ATA interface will have a connection structure between the host and the peripheral storage devices that is significantly different from that of the parallel ATA. Therefore, a new connector structure to support the Serial ATA interface is needed.

### SUMMARY OF THE INVENTION

An aspect of the present invention is to provide a single modular connector assembly that can accommodate a plurality of connections between a host and a plurality of peripheral devices.

Another aspect of the present invention is to provide a modular connector assembly that occupies minimal surface area and can be rapidly mounted onto, for example, a host, device, or frame to accommodate a plurality of connections between a host and a plurality of peripheral devices or link a plurality of devices together.

To attain at least the foregoing objectives, the present invention provides a modularized multi-connector module that comprises a body having a plurality of slots therein. Each slot in the body comprises a plurality of signal contacts and is shaped such that the peripheral devices can be connected to a host via a plurality of cables individually plugged in the slots of the modular multi-connector assembly.

The Serial ATA interface will have a separate cable to connect each device with the motherboard of the computer. The Serial ATA signal connector is a 7-pin connector, and while it has fewer pins than the Parallel ATA 40-pin connector, the Serial ATA interface requires a separate connector receptacle for each device. Therefore, a motherboard would have four separate connector receptacles in order to accommodate 4 storage devices.

However, with the present invention, one modular connector assembly is able to allow four separate devices to connect to the motherboard or device. This modular connector assembly also provides a much smaller footprint saving valuable motherboard area.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a perspective view schematically illustrating a conventional ATA connection interface;

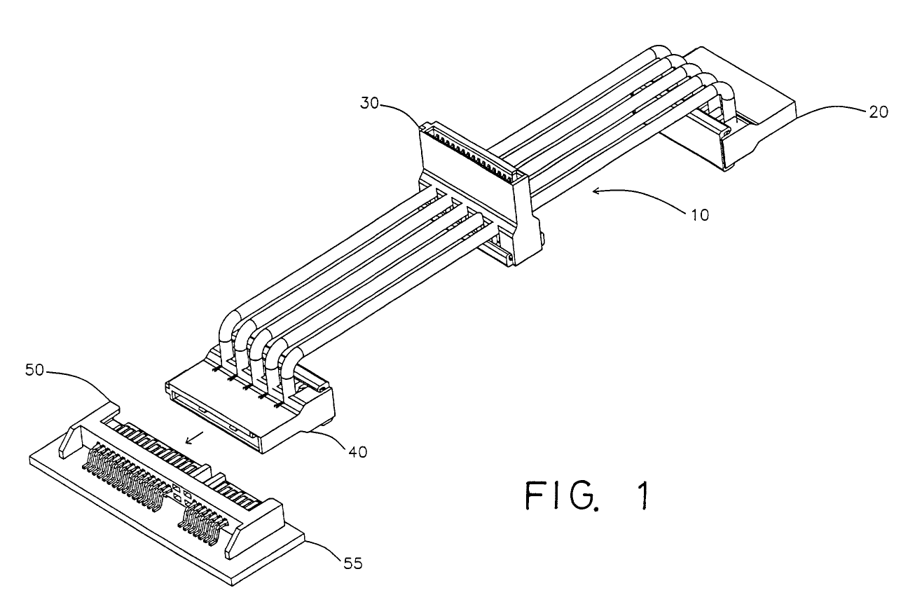

FIG. 2 is a perspective view schematically illustrating a modular connector assembly according to an embodiment of the present invention; and

FIG. 3 is a perspective view illustrating a modular connector assembly according to an embodiment of the present invention.

### DETAILED DESCRIPTION OF THE PREFERRED EMBODIMENTS

The following detailed description of the embodiments and examples of the present invention with reference to the accompanying drawings is only illustrative of specific structures and ways of making of the present invention, and does not limit the scope of the present invention. Wherever possible in the description, like reference numerals will refer to like elements and parts unless otherwise illustrated.

In comparison with the current parallel ATA, the new serial ATA is expected to eliminate the performance bottleneck of the current parallel ATA, and offer other advantages including reduction in operating voltages, smaller and easier-to-route cables, and improved data robustness.

With respect to the device connection structure, the serial ATA interface significantly differs from the parallel ATA interface. Instead of being connected to two storage devices via a single parallel ATA connector, the host views the different storage devices as masters on separate ports. Therefore, the serial ATA structure connects each of the storage devices with individual cables in a point-to-point fashion.

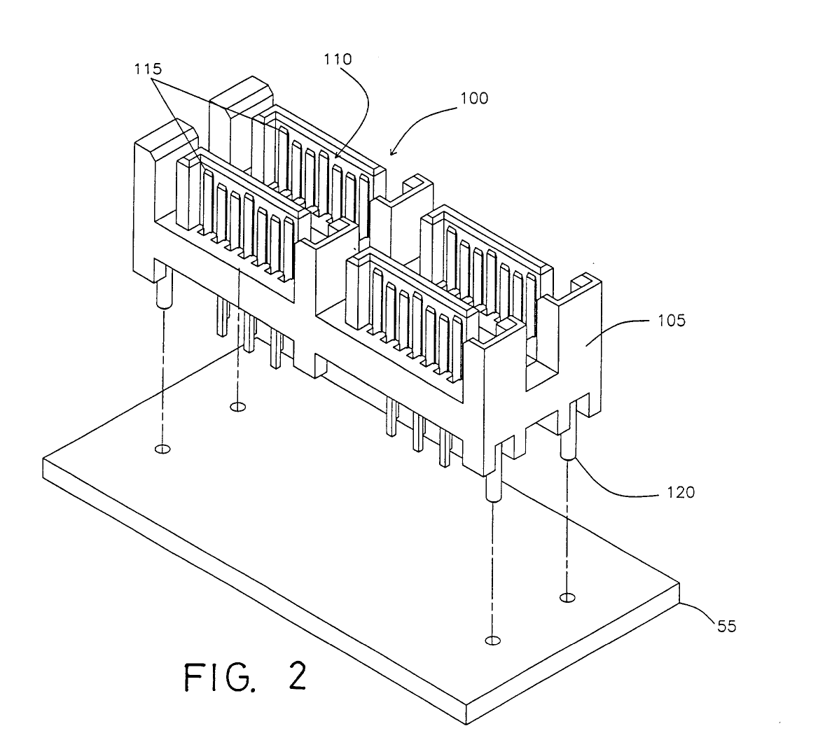

Referring to FIG. 2, a perspective view schematically illustrates a multi-connector module suitable for use with, for example, serial ATA interface according to an embodiment of the invention. In view of the requirement of the serial ATA interface for multi-device connection, the present invention provides a modular connector assembly or multi-connector module 100 for multiple device connections to the host 55.

The multi-connector module 100 comprises a body 105 preferably made of plastic material in which a plurality of slots 110 is formed. Each slot 110 includes therein a plurality of signal contacts 115 that may be defined in accordance with the serial ATA interface specification. Each slot 110 with its signal contacts 115 hence form a serial ATA connector into which a serial ATA cable with a complementary connector (not shown) can be plugged in. The attachment of the multi-connector module 100 onto the host 55 may be achieved by, for example, screw/bolt assemblies 120.

One advantage of the multi-connector module 100 of the invention is that the surface area taken by an arrangement of several connectors is minimal. Instead of four separate connectors spread across the motherboard, only one modular connector is required. Another advantage is that by gathering a plurality of connectors within a single multi-connector module, the mounting of connectors on the host 55 is performed only one time instead of repeating a same fixing operation for mounting separate connectors. Moreover, a single multi-connector module favorably reduces the number of attachment points. Cumbersome operations such as accurate arrangement of the attachment points on the connector and on the host 55 can be therefore reduced.

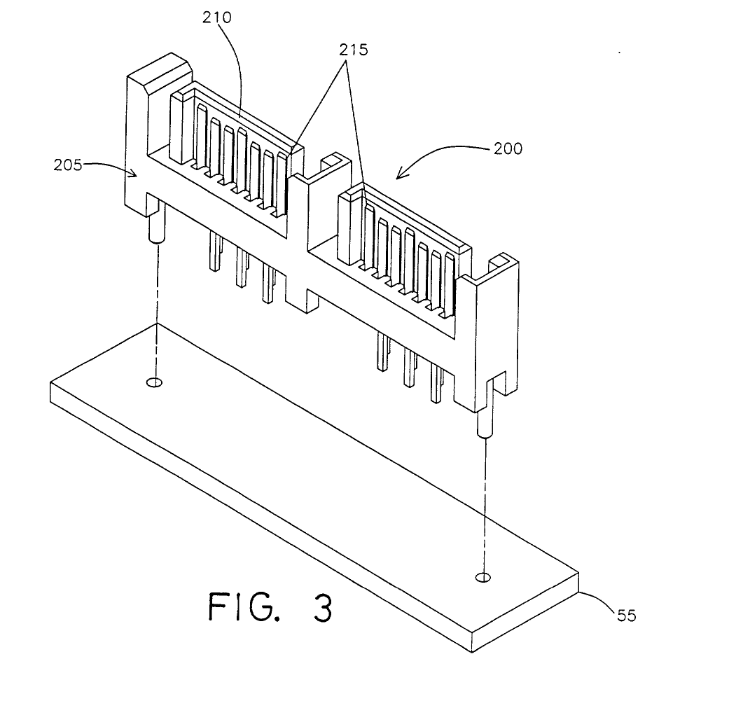

Refer to FIG. 3, which is a perspective view illustrating a modular connector assembly according to an embodiment of the present invention.

The multi-connector module 200 comprises a body 205 preferably made of plastic material in which a plurality of slots 210 is formed. Each slot 210 includes therein a plurality of signal contacts 215 that may be defined in accordance with the serial ATA interface specification. Each slot 210 with its signal contacts 215 hence form a serial ATA connector into which a serial ATA cable with a complementary connector (not shown) can be plugged in. The attachment of the multi-connector module 200 onto the host 55 may be achieved by various attachment means 220.

It is apparent that the above advantages can be obtained for other types of connectors by simple modification of the above multi-connector module of the invention. For example, a similar multi-connector module can be adapted from Serial ATA interface into a universal serial bus (USB) interface on a USB hub or a 1394 interface on a 1938 hub. Manufacturing a single modular connector not only saves time and money, but saves surface area as well. In addition, the above embodiments describe motherboard connections. However, in other embodiments of the present invention, the modular connector assembly is situated on a device or computer frame and accommodates internal and external devices.

It will be apparent to those skilled in the art that various modifications and variations can be made to the structure and operations of the present invention without departing from the scope or spirit of the invention.

What is claimed is:

1. A multi-connector module for connecting a plurality of peripheral devices to a host, the multi-connector comprising:
a body having a plurality of slots; and
a plurality of signal contacts arranged in the slots, wherein the peripheral devices can be connected to the host by mounting the multi-connector module onto the host and individually plugging a plurality of cables in each slot of the multi-connector module.

2. The multi-connector module of claim 1, wherein the plurality of cables are serial ATA cables.

3. The multi- connector module of claim 1, wherein the plurality of cables are 1394 cables.

4. The multi-connector module of claim 1, wherein the plurality of cables are universal serial bus cables.

5. A modular electrical connector assembly for connecting a plurality of electrical connectors comprising:
a body having a plurality of slots; and
a plurality of signal contacts arranged in the plurality of slots, wherein the plurality of electrical connectors are inserted into the slots allowing signals present on the signal contacts to be electrically transferred to at least one of the plurality of electrical connectors.

6. The modular electrical connector assembly of claim 5, wherein the electrical connectors are Serial ATA connectors.

7. The modular electrical connector assembly of claim 5, wherein the electrical connectors are universal serial bus connectors.

8. The modular electrical connector assembly of claim 5, wherein the electrical connectors are 1394 connectors.
